(19) United States
(12) Patent Application Publication
(10) Pub. No.: US 2022/0393173 A1
(43) Pub. Date: Dec. 8, 2022

(54) Lithium Deposition and Battery Using Inorganic Molten Salts

(71) Applicant: Pure Lithium Corporation, Charlestown, MA (US)

(72) Inventors: Donald R. Sadoway, Cambridge, MA (US); Paul J. Burke, Framingham, MA (US)

(21) Appl. No.: 17/832,321

(22) Filed: Jun. 3, 2022

Related U.S. Application Data
(60) Provisional application No. 63/197,091, filed on Jun. 4, 2021.
(60) Provisional application No. 63/221,546, filed on Jul. 14, 2021.

(51) Int. Cl. H01M 4/60; H01M 10/052; H01M 10/54; H01M 10/056; H01M 10/39; H01M 4/38; H01M 4/62; H01M 10/44

(52) U.S. Cl. CPC H01M 4/604; H01M 10/052; H01M 10/54; H01M 10/056; H01M 10/399; H01M 4/382; H01M 4/624; H01M 10/44; H01M 2004/027

(57) ABSTRACT

A conformable polymer coated lithium metal electrode provides the negative electrode and the solid electrolyte for a rechargeable lithium metal battery that further includes an inorganic molten salt electrolyte having a melting temperature below 140° C. interposed between the conformable polymer coating and a positive electrode. In some embodiments, the conformable polymer is a block or graft copolymer. Optionally, the positive electrode includes elemental sulfur in a conductive matrix. The conformable polymer coated lithium metal electrode may be manufactured by a process involving electroplating lithium metal through a conformable polymer coated conductive substrate. The conformable polymer coated conductive substrate may be prepared by coating the conductive substrate in a conformable polymer solution followed by evaporating the solvent. Alternatively, a lithium metal electrode may be coated directly with conformable polymer.

### CROSS-REFERENCE TO RELATED APPLICATIONS

This patent application claims the benefit of U.S. Provisional Patent Application No. 63/197,091 filed Jun. 4, 2021, and U.S. Provisional Patent Application No. 63/221,546 filed Jul. 14, 2021. These applications are hereby incorporated, in their entirety, by reference.

### TECHNICAL FIELD

The present invention relates to the manufacture of lithium metal rechargeable batteries using inorganic molten salts. The resultant batteries are safer and have increased cycle life compared to lithium metal batteries manufactured by conventional methods.

### BACKGROUND ART

Lithium ion batteries (LIBs) dominate the lithium battery market. LIBs contain no metallic lithium present as such. The negative electrode comprises a carbon host for neutral lithium which is contained therein. In the electrolyte and in the positive electrode lithium is present only as the ion. Such batteries are attractive for their high energy density compared to that of other rechargeable batteries and for their ability to operate over multiple charge/discharge cycles. However, the organic electrolytes typically used in LIBs are flammable and are a safety hazard if the batteries overheat.

In lithium metal batteries (LMBs) the negative electrode comprises metallic lithium. During discharge of an LMB, lithium metal dissociates to form lithium ions and electrons. The lithium ions migrate through the electrolyte to the positive electrode. The electrons flow through an external circuit where they power a device. As the LMB recharges, lithium ions are reduced back to lithium metal as electrons flow back into the negative electrode. Because LMBs have intrinsically higher capacity than LIBs, they are the preferred technology for primary batteries. Moreover, since LMBs can be manufactured in the fully charged state, they do not require the lengthy formation process needed for LIBs. However, poor cycle life, volumetric expansion, and safety concerns relating to shorts resulting from dendrite formation and the potential for violent combustion of flammable organic electrolytes have limited their practical use as rechargeable batteries.

Lithium metal batteries using sulfur as the positive electrode offer higher specific capacity than the lithium intercalation compounds that currently dominate the market. However, complex polysulfide species produced upon the reduction of elemental sulfur are soluble in the organic electrolytes typically used in lithium batteries, resulting in reduced electrochemical performance and cycle life due to the “polysulfide shuttle” effect.

Solid state electrolytes (SSEs) can ameliorate the safety concerns for lithium batteries, and can reduce polysulfide reduction processes at the negative electrode that degrade battery performance and cycle life. However, SSEs can also result in high impedance at the positive electrode, thereby reducing output voltage and hence battery efficiency.

Inorganic molten salts provide another electrolyte alternative, with non-flammability and high ionic conductivities as attractive attributes. Inorganic molten salts can make use of common inexpensive materials. However, the choices of inorganic molten salts that can serve as solvents for lithium ions are limited by the low, i.e., cathodic, reduction potential of lithium ion compared to that of other metallic cations, meaning that most common low temperature inorganic molten salts incorporate the salts of metals that are more noble than lithium and will thus preferentially electroplate to it during battery recharging.

Low temperature ionic liquids with complex organic cations provide some of the benefits of inorganic molten salts, but are significantly more expensive, and have decreased ionic conductivities compared to inorganic molten salts.

A novel rechargeable lithium metal battery and methods to produce the same are needed to improve the electrochemical efficiency, increase cycle life and enhance the safety profile of rechargeable lithium metal batteries, in particular lithium metal batteries using elemental sulfur in the positive electrode.

### SUMMARY OF THE EMBODIMENTS

In accordance with embodiments of the invention, a rechargeable lithium metal battery is disclosed, the rechargeable lithium metal battery having a negative electrode, the negative electrode having a conductive substrate coated with a layer of lithium metal, the layer of lithium metal having an inner face and an outer face, the inner face contacting the conductive substrate. The embodied rechargeable lithium metal battery further has a positive electrode, a solid electrolyte comprising a lithium ion conductive conformable polymer coating the outer face of the lithium metal, a lithium salt dispersed within the solid electrolyte, and an inorganic molten salt electrolyte, wherein the melting temperature of the inorganic molten salt electrolyte is less than 140° C. For such embodiments, the inorganic molten salt electrolyte is disposed between the solid electrolyte and the positive electrode, and is in direct physical contact with both the solid electrolyte and the cathode.

According to some embodiments of the rechargeable lithium metal battery, the lithium ion conductive conformable polymer is a graft or block copolymer with first segments and second segments, each segment above its respective glass transition temperature, T_{g}, the first segment formed from lithium ion solvating groups and the second segment being immiscible with the first segment, wherein the lithium ion conductive copolymer forms microphase separated first domains and second domains, the first domains formed from the first segments and providing continuous conductive pathways for the transport of lithium ions and the second domains formed from the second segments. For some such embodiments, the lithium ion solvating chains comprise poly(oxyethylene)ₙ side chains, where n is an integer between 4 and 20.

For some embodiments the lithium ion conductive conformable polymer is a block polymer for which the second segments comprise poly(alkyl methacrylate). For some such embodiments the lithium ion conductive conformable polymer is poly[(oxyethylene)₉ methacrylate]-b-poly(laurel methacrylate) (POEM-b-PLMA). For some such embodiments the ratio of POEM to PLMA is between 55:45 and 70:30 on a molar basis.

For some embodiments the lithium ion conductive conformable polymer is a graft polymer for which the second segments comprise poly(dimethyl siloxane). For some such embodiments, the lithium ion conductive copolymer is poly[(oxyethylene)₉ methacrylate]-g-poly(dimethyl siloxane).

According to some embodiments, the inorganic molten salt electrolyte includes at least one ionic species having a higher reduction potential than Li⁺. According to some embodiments, the inorganic molten salt electrolyte includes one or more salts selected from the group consisting of aluminum salts, titanium salts, alkali metal salts, alkaline earth metal salts, ammonium salts, and combinations thereof. For some embodiments, the inorganic molten salt electrolyte includes aluminum salts, and wherein the molar percentage of the aluminum salts is at least 50%. For some such embodiments, the aluminum salts include aluminum chloride at a molar percentage of at least 50%.

For some embodiments, the inorganic molten salt electrolyte includes anions chosen from the group consisting of halides, nitrates, nitrites, sulfates, sulfites, carbonates, hydroxides and combinations thereof. For some embodiments, the positive electrode includes elemental sulfur. For some embodiments the positive electrode is porous and infiltrated by the inorganic molten salt electrolyte.

For some embodiments the melting temperature of the inorganic molten salt electrolyte is less than 100° C. For some embodiments the melting temperature of the inorganic molten salt electrolyte is less than 75° C. For some embodiments, the melting temperature of the inorganic molten salt electrolyte is less than 50° C. For some embodiments the melting temperature of the inorganic molten salt electrolyte is less than 30° C.

According to some aspects of the invention, a process is disclosed for manufacturing a lithium metal electrode, the process including the steps of:

(1) configuring a lithium ion conductive conformable polymer coated conductive substrate as a cathode in an electrolytic cell;

(2) configuring a lithium ion source as an anode for the electrolytic cell;

(3) disposing an inorganic molten salt electrolyte between the solid electrolyte and the anode, so that the inorganic molten salt electrolyte is in direct physical contact with both the lithium ion conductive conformable polymer and the anode, wherein the melting temperature of the inorganic molten salt electrolyte is less than 140° C., and wherein the inorganic molten salt electrolyte includes at least one ionic species having a higher reduction potential than Li⁺;

(4) applying a voltage across the anode and the conductive substrate, thereby depositing a layer of lithium metal on the surface of the conductive substrate, sandwiched between the conductive substrate and the lithium ion conductive conformable polymer coating.

For some embodiments, a lithium metal electrode is disclosed that is manufactured according to such a manufacturing process. For some such processes, the anode comprises an electrode from a recycled battery, the recycled battery being chosen from the group consisting of a lithium metal battery and a lithium ion battery.

For some such manufacturing processes, the lithium ion conductive conformable polymer is a graft or block copolymer with first segments and second segments, each segment above its respective glass transition temperature, T_{g}, the first segments formed from lithium ion solvating groups and the second segments being immiscible with the first segments, wherein the block or graft copolymer forms microphase separated first domains and second domains, the first domains formed from the first segments and providing continuous conductive pathways for the transport of lithium ions and the second domains formed from the second segments.

For some processes, the lithium metal electrode is manufactured with the first segments comprising poly(oxyethylene)ₙ side chains, where n is an integer between 4 and 20. For some such processes, the lithium ion conductive copolymer is a block copolymer for which the second segments comprise poly(alkyl methacrylate). For other such processes, the lithium ion conductive polymer is a graft copolymer for which the second segments comprise poly(dimethyl siloxane).

For some such processes the lithium ion conductive copolymer is poly[(oxyethylene)₉ methacrylate]-b-poly(laurel methacrylate) (POEM-b-PLMA). For some such processes, the lithium ion conductive copolymer is poly[(oxyethylene)₉ methacrylate]-g-poly(dimethyl siloxane). For some such processes, the lithium metal electrode is coated with lithium ion conductive copolymer with a ratio of POEM to PLMA of between 55:45 and 70:30 on a molar basis.

For some manufacturing processes, the block or graft copolymer coated conductive substrate is prepared by a method including:

(1) preparing a coating solution by dissolving the block or graft copolymer in a cosolvent, each segment of the lithium ion conductive copolymer being separately soluble in the cosolvent;

(2) coating a conductive substrate with the coating solution;

(3) evaporating the cosolvent from the coated conductive substrate so that the conductive substrate is coated with a layer of the block or graft copolymer.

### BRIEF DESCRIPTION OF THE DRAWINGS

The foregoing features of embodiments will be more readily understood by reference to the following detailed description, taken with reference to the accompanying drawings, in which:

FIG. 1 illustrates the structural features of block and graft copolymers.

FIG. 2 embodies a lithium metal battery constructed with a single polymer coated lithium electrode and a single positive electrode.

FIG. 3 embodies a lithium metal battery constructed with a single polymer coated lithium electrode and two positive electrodes.

FIG. 4 shows steps for producing a lithium metal electrode according to embodiments of the invention.

FIG. 5 shows an electrolytic cell for producing a lithium metal electrode according to embodiments of the invention, prior to the application of electroplating current.

FIG. 6 shows the electrolytic cell of FIG. 5 after the application of electroplating current.

FIG. 7a provides a cross-sectional view of a polymer coated conductive substrate prior to electroplating lithium metal onto the substrate according to embodiments of the invention.

FIG. 7b provides a top view of a polymer coated conductive substrate prior to electroplating lithium metal onto the substrate according to embodiments of the invention.

FIG. 8a provides a cross-sectional view of the conductive substrate of FIGS. 7a and 7b after electroplating lithium metal onto the substrate to form a lithium metal layer sandwiched between the conductive substrate and the polymer coating according to embodiments of the invention.

FIG. 8b provides a top view of the conductive substrate of FIG. 8a according to embodiments of the invention.

### DETAILED DESCRIPTION OF SPECIFIC EMBODIMENTS

Definitions. As used in this description and the accompanying claims, the following terms shall have the meanings indicated, unless the context otherwise requires:

A “solid electrolyte” is solid material that at room temperature allows ion transport between electrodes of an electrolytic or galvanic cell. For the purposes of this application, a “solid electrolyte” is understood to include a material such as a gel, that has microscopic regions with liquid-like behavior, but that maintains its overall shape.

A “molten salt” is a salt or combination of salts above its melting point, present as a liquid phase that is ionically conductive. A “molten salt” is an electrolyte by virtue of its ionic conductivity.

An “ionic liquid” is a room-temperature molten salt. Exemplary ionic liquids have bulky organic cations such as the 1-ethyl-3-methylimidazolium (EMIM) cation, for example EMIM:Cl and EMIM:Ac (acetate anion).

An “inorganic molten salt” is an inorganic salt composition above its melting temperature. Exemplary inorganic molten salts include metal halides, e.g., sodium chloride (NaCl), and metal nitrates, e.g., silver nitrate (AgNO₃).

A “block copolymer” is polymer with blocks made up of one monomer alternating with blocks of another monomer along a linear polymer strand.

A “graft copolymer” is a polymer which has a backbone strand made up of one type of monomer and branches of a second monomer.

As used herein, a “conformable polymer” is an amorphous elastomeric polymer above its glass transition temperature, capable of extensive molecular rearrangement, allowing the polymer to stretch and retract in response to macroscopic stress. When present as a coating on a substrate, such a conformable polymer has the mechanical properties of a solid, but can shrink and expand to adapt to volume changes of the substrate, while continuing to coat the substrate. The block and graft copolymers of the present invention are “conformable polymers.”

A “segment” is a block for a block copolymer and a side chain or backbone for a graft copolymer.

“Microphase separation” of a block or graft copolymers occurs when polymer chains segregate into domains according to their monomeric units.

A “cosolvent” for different monomers is a solvent capable of dissolving each of the different segments of a block or graft copolymer.

A “common solvent” is identical with a “cosolvent.”

A “negative electrode” functions as an anode in a galvanic cell and as a cathode in an electrolytic cell.

A “positive electrode” functions as a cathode in a galvanic cell and as an anode in an electrolytic cell.

The “reduction potential” of a chemical species provides a measure in volts, of the tendency of the chemical species to undergo electrochemical reduction by accepting electrons. A higher reduction potential implies a greater tendency to accept electrons and be reduced. A metal that is more “noble” has a greater tendency to keep its electrons, and the cations of that metal have a higher reduction potential when compared with a metal that is less “noble.”

Lithium cation has one of the lowest reduction potentials of all metal cations. In other words, lithium is one of the least “noble” metals.

The tendency for lithium metal batteries to form dendrites can lead to electrical shorting across the cell. The common use of flammable organic electrolytes for such batteries exacerbates the potential of such shorts to lead to fires and explosions. Solid electrolytes are generally less flammable, and can be designed for ion selectivity. Solid electrolytes in intimate contact with lithium metal electrodes can limit dendrite formation, thereby extending battery life. However, conventional solid electrolytes with ion selective ceramic materials are fragile, brittle and prone to breakdown due to volume changes in the adjoining electrodes during charging and recharging cycles, which can limit battery life. Moreover, the interface between solid electrolytes and electrode surfaces can provide a significant impedance barrier, reducing output voltage and hence battery efficiency.

The ideal solid electrolyte has the ion transport properties of a liquid, the ability to preferentially transport desired ionic species, while blocking the undesirable transport of any other species. The ideal solid electrolyte has low flammability, and a resistance to dendrite formation. The ideal solid electrolyte has the mechanical properties of a solid, but can undergo molecular rearrangements to grow, to shrink, and to accommodate volume changes associated with battery charging and recharging while still maintaining physical contact with electrodes. According to embodiments of the present invention, solid electrolytes of improved design, incorporating conformable polymers, approach ideal solid electrolyte behavior.

In some embodiments, the conformable polymer according to this invention is a block or graft copolymer having one or more “A” segments interspersed with one or more “B” segments, wherein the “A” segments are capable of solvating lithium salt, and the “B” segments are not compatible with the “A” segments. All segments are above their respective glass transition temperatures, T_{g}. Material comprising such a block or graft copolymer will microphase separate into locally segregated nanoscale domains of “A” and “B” segments. The resultant ordering of segments in turn confers conformational rigidity to the material even though all of the constituents are segmentally liquid. For suitable A:B ratios, the A segments form continuous lithium ion solvating channels. For lithium ion solvating chains having suitably high local chain mobility, high lithium conductivity allows the directed flow of lithium ions through the copolymer upon application of an electric field. Doping the copolymer with a lithium salt according to embodiments of the invention ensures a high selectivity for lithium cations.

Inorganic molten salt electrolytes have excellent ionic conductivities and low flammability. However, due to their high melting points, inorganic molten salt electrolytes for lithium batteries are typically limited to dangerously high temperatures, in the range of 400 to 500° C. under which conditions they can rapidly corrode conventional battery containment materials. Moreover, because the melting temperature of lithium metal is 180.5° C., cells operating at these temperatures can potentially leak highly reactive molten lithium. The use of ionic liquid electrolytes with melting temperatures below room temperature can overcome some of these problems, but such electrolytes are expensive, and have reduced charge transfer rates compared to those of inorganic molten salts.

Compositions of inorganic molten salts according to embodiments of the present invention have melting temperatures (Tₘs) below 140° C. Inorganic molten salts according to some embodiments of the present invention comprise solutions of AlCl₃ and may include LiCl, NaCl, and KCl. Some such embodied chloroaluminate molten salt electrolytes can operate at temperatures at or near the boiling point of water. In other embodiments of the invention, inorganic molten salts formed from nitrate salts likewise have Tₘs well below 100° C.

The inorganic molten salt electrolytes of the instant invention are non-flammable. Because these inorganic molten salt electrolytes operate at temperatures well below the melting point of lithium, they are not significantly corrosive, and there is no danger from the leakage of molten lithium.

In order to obtain low Tₘ inorganic molten salts, in some embodiments of the instant invention, inorganic species are incorporated into the inorganic molten salts that have higher reduction potentials than lithium cation. Even though those species would ordinarily electroplate preferentially compared to lithium, they are blocked from doing so by the layer of conformable polymer functioning as a solid electrolyte.

Embodiments of the instant invention protect the negative electrode of a lithium metal electrochemical cell with a layer of conformable polymer that provides lithium ion selectivity, allowing the use of low Tₘ inorganic molten salt electrolytes that include ionic species with a higher reduction potential than that of Li⁺. When lithium metal batteries are constructed according to embodiments of the invention with such conformable polymer coated negative electrodes, and with a low Tₘ inorganic molten salt electrolyte between the polymer and the positive electrode, the facile ion transport through liquid-like lithium channels of the conformable polymer at the negative electrode, and the ability of the inorganic molten salt electrolyte to penetrate the pores of the positive electrode, together provide a high energy density, low impedance barrier battery, with a significantly improved cycle life, reduced threat of dendrite formation, and enhanced safety profile. The ability of the conformable polymer to undergo molecular rearrangements to adjust to volume changes and to self-heal if damaged reduces the detrimental effects of such volume changes during cycling, further enhancing battery life.

Lithium sulfur (Li—S) batteries using sulfur as the positive electrode offer higher specific capacity than the lithium intercalation compounds that currently dominate the market. However, complex polysulfide species produced upon the reduction of elemental sulfur dissolve in the organic electrolytes typically used in lithium batteries, resulting in reduced cycle life due to the “polysulfide shuttle” effect. The polysulfide shuttle effect is reduced for batteries according to the instant invention. Without being bound by theory, this reduction is hypothesized to result from reduced solubility of polysulfide species in the inorganic molten salt electrolyte, combined with blockage of polysulfide transport by the conformable polymer solid state electrolyte.

Consequently, another desirable feature of lithium metal batteries according to the instant invention is the ability to block the “polysulfide shuttle” between the positive and negative electrodes that reduces battery performance and cycle life of Li—S batteries.

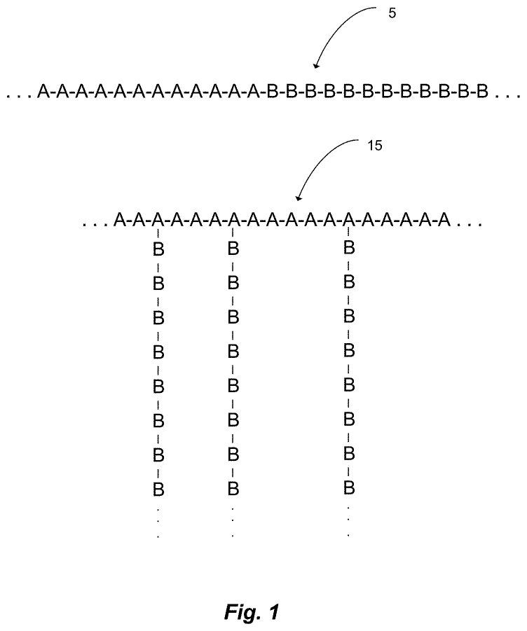

As illustrated in FIG. 1, block copolymers 5 of embodiments of the invention have alternating blocks of monomer units, here designated by type “A” and type “B” monomers. In contrast graft copolymers 15 of embodiments of the invention have a backbone made up of type “A” monomers and side-chains of type “B” monomers. The block copolymer 5 of FIG. 1 is a di-block polymer (AB) with one block of A and one block of B. In other embodiments, block copolymers can be tri-block (ABA or BAB) or multi-block copolymers.

Block copolymers with blocks of immiscible groups and graft copolymers with immiscible backbone and side-chain segments as embodied in this application are conformable polymers that provide a solid electrolyte with the ion transport properties of a liquid and with the ability to preferentially transport desired ionic species, while blocking the transport of undesirable species. The thus embodied solid electrolyte has low flammability and a resistance to dendrite formation. The thus embodied solid electrolyte has the mechanical properties of a solid but can undergo molecular rearrangements to grow, to shrink, and to accommodate volume changes associated with positive and negative electrodes while still maintaining physical contact with both positive and negative electrodes.

Consequently, conformable polymers in the form of block copolymers with blocks of immiscible groups and graft copolymers with immiscible backbone and side-chain segments as embodied in this application provide a solid electrolyte technology for lithium metal batteries in general and Li—S batteries in particular with improved safety and performance, longer battery life, and a solution to the “polysulfide shuttle” problem. In short, block copolymers and graft copolymers as embodied in this application provide the key features of an ideal solid electrolyte for lithium metal batteries.

A block or graft copolymer as embodied in this application has one or more “A” segments of lithium salt solvating polymers interspersed with one or more “B” segments. All segments are above their respective glass transition temperatures, T_{g}. Material incorporating such a block or graft copolymer will microphase separate into locally segregated nanoscale domains of “A” and “B” segments. The resultant ordering of segments in turn confers conformational rigidity to the material even though all of the constituents are segmentally liquid. For suitable A:B ratios, the A segments form continuous lithium ion solvating channels. For lithium ion solvating chains having suitably high local chain mobility, high lithium conductivity allows the directed flow of lithium ions through the copolymer upon application of an electric field.

Dissolving the block or graft copolymer in a suitable common solvent (cosolvent) that is capable of dissolving both A and B segments allows ready processing of the polymer by conventional coating methods. For example, electrodes can be directly coated with block or graft copolymer electrolyte by dipping the electrode in a solution of copolymer with cosolvent, and allowing the cosolvent to evaporate. Such an electrode can then be directly used in a battery or electrolytic cell. In this manner, as described below, lithium metal electrodes can be coated with lithium ion conducting block or graft copolymer solid electrolytes for use in solid state batteries.

Suitable copolymers can be di-block copolymers (AB), tri-block copolymers (ABA or BAB), or higher multiblock polymers with alternating A and B blocks. All blocks are above their respective glass transition temperatures, T_{g}. Likewise suitable are graft copolymers with backbone A monomers and side-chain B monomers, or back-bone B monomers and side-chain A monomers. In some embodiments, the A segments incorporate short poly(oxyethylene)ₙ side chains, where n, the number of oxyethylene groups in the side chain ranges from 4 to 20, preferably between 7 and 11. In some embodiments n is equal to nine. In some embodiments the poly(oxyethylene)ₙ side chains are incorporated by polymerization of poly(oxyethylene)ₙ methacrylate monomers. In a preferred embodiment, the A segments are synthesized by polymerization of poly(oxyethylene)₉ methacrylate monomers.

In some embodiments, the B segments have alkyl side chains having from 4 to 12 carbons. In some embodiments, the B segments are synthesized from a poly(alkyl methacrylate). In some embodiments, the poly(alkyl methacrylate) is chosen from the group consisting of poly(butyl methacrylate), poly(hexyl methacrylate), and poly(laurel methacrylate). In a preferred embodiment, the poly(alkyl methacrylate) is poly(laurel methacrylate).

In some embodiments the “A” segments incorporate a mixture of neutral and anionic groups. In some such embodiments, the anionic groups are configured in order to minimize coordination of the anionic groups with lithium cations.

In a preferred embodiment, the copolymer is the di-block copolymer poly[(oxyethylene)₉ methacrylate]-b-poly(laurel methacrylate) (POEM-b-PLMA).

In some embodiments, the block copolymers are synthesized by living anionic polymerization. In some embodiments, the block copolymers are synthesized by atom transfer radical polymerization (ATRP).

In some embodiments, the conformable polymer is a graft copolymer with a backbone of “A” segments that are lithium salt solvating and “B” segments that phase separate from the “A” segments. Each segment is above its respective glass transition temperature, T_{g}.

In a preferred embodiment, the graft copolymer has backbone “A” segments incorporating short poly(oxyethylene)ₙ side chains, where n, the number of oxyethylene groups in the side chain ranges from 4 to 20, preferably between 7 and 11. In some embodiments, n is equal to nine. In some embodiments, the poly(oxyethylene)ₙ side chains are incorporated by polymerization of poly(oxyethylene)ₙ methacrylate monomers. In a preferred embodiment, the A segments are synthesized by polymerization of poly(oxyethylene)₉ methacrylate monomers.

In some embodiments, the conformable polymer is a graft copolymer with side chain “B” segments incorporating poly(dimethyl siloxane) (PDMS). In a preferred embodiment, the graft copolymer is incorporated into a poly(oxyethylene)ₙ methacrylate backbone by random copolymerization of poly(dimethyl siloxane) monomethacrylate macromonomer (PDMSMA) with poly(oxyethylene)ₙ methacrylate monomers to form a graft copolymer of type POEM-g-PDMS. In preferred embodiments, poly(oxyethylene)₉ methacrylate monomers are reacted to form the POEM-g-PDMS copolymer.

In some embodiments, the “A” backbone includes additional monomers. In some embodiments the additional monomers are anionic. In an embodiment, poly(oxyethylene)₉ methacrylate monomers are copolymerized with methacrylate monomers (MAA) and with PDMSMA to form poly(oxyethylene)₉-ran-MAA-g-PDMS. In a preferred embodiment, the carboxylic acid groups of this polymer are reacted with BF₃ to give anionic boron trifluoride esters, which have a reduced tendency to complex lithium ions when compared with MAA carboxylate groups.

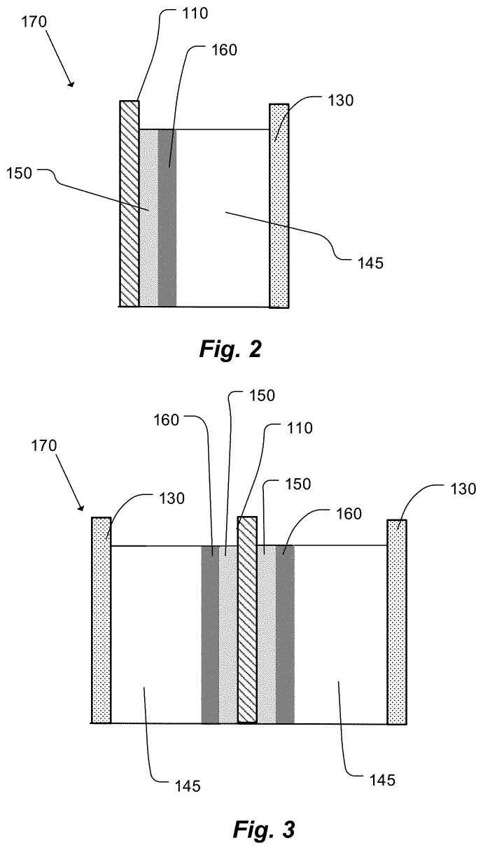

In the rechargeable battery 170 embodied in FIG. 2, the negative electrode is provided by a conductive substrate 110, which is coated with a layer of lithium metal 150. The layer of lithium metal 150 is sandwiched between the conductive substrate 110 on a first side and a conformable polymer solid electrolyte 160 on a second side. Opposite the conformable polymer solid electrolyte 160 is a single positive electrode 130. Juxtaposed between the conformable polymer solid electrolyte and the single positive electrode, and physically contacting both is an inorganic molten salt electrolyte 145. The single positive electrode 130 is wetted with the inorganic molten salt electrolyte 145. In preferred embodiments, the positive electrode 130 is porous and infiltrated with the inorganic molten salt electrolyte.

In the rechargeable battery 175 embodied in FIG. 3, a single negative electrode includes a conductive substrate 110, the conductive substrate coated on all sides with a layer of lithium metal 150. The lithium metal 150 is in turn sandwiched between a layer of conformable polymer solid electrolyte 160. Two positive electrodes 130 are provided at opposite sides of the cell, with each being separated from the conformable polymer solid electrolyte 160 by inorganic molten salt electrolyte, the inorganic molten salt electrolyte 145 physically contacting the conformable polymer solid electrolyte 160. The two positive electrodes 130 are wetted by the inorganic molten salt electrolyte 145. In preferred embodiments, the positive electrode 130 is porous and infiltrated with the inorganic molten salt electrolyte 14.

In preferred embodiments of the batteries of FIGS. 2 and 3, a lithium salt is dispersed within the conformable polymer. In some embodiments, the lithium salt is LiCF₃SO₃. In some embodiments the conformable polymer is a block or graft copolymer with ethylene oxide segments. In some such embodiments LiCF₃SO₃ is dispersed within the block or graft copolymer at a molar ratio of between 50:1 and 10:1 ethylene oxide to lithium ion. In a preferred embodiment, the LiCF₃SO₃ is dispersed within the block or graft copolymer at a molar ratio of 20:1 ethylene oxide to lithium ion. In some embodiments, the block or graft copolymer with dispersed lithium salt coating the negative electrode is formed by solution casting directly from anhydrous tetrahydrofuran (THF).

In some embodiments, the positive electrodes of the rechargeable batteries of FIGS. 2 and 3 include intercalative lattice structures of transition metal compounds capable of incorporating Li+. In some embodiments, the positive electrodes include materials chosen from the group consisting of layered structures, spinel phase transition metal oxides, olivine phase transition metal phosphates, nickel-manganese-cobalt (NMC) and nickel-cobalt-aluminum (NCA) structures. In some embodiments the layered structures have the formula LiMO₂, where M is Fe, Mn, Ni, or Co. In some embodiments the spinel phase transition metal oxides have the formula LiM₂O₄, where M is Ni or Mn. In some embodiments the olivine transition metal phosphates have the formula LiMPO₄, where M is Fe, Mn or Co.

In some embodiments the rechargeable batteries of FIGS. 2 and 3 are lithium-chalcogen batteries, for which the positive electrode includes elemental chalcogen chosen from the group consisting of sulfur, selenium, tellurium, and combinations thereof. In some embodiments, the batteries are Li—S batteries, for which the positive electrode includes elemental sulfur. In preferred embodiments, the chalcogen in the positive electrode is associated with a conductive matrix, enabling suitably high electron conductivity.

Li—S batteries constructed in the manner of FIGS. 2 and 3 enable Li⁺ transport, but block the transport of anions, including in particular polysulfide anions. Consequently, the polysulfide shuttle responsible for reducing the performance and cycle life of Li—S batteries is vitiated.

In embodiments of the batteries of FIGS. 2 and 3, the inorganic molten salt has a melting point (Tₘ) less than 140° C. In some embodiments, the inorganic molten salt 145 has a Tₘ less than 100° C. In some embodiments, the inorganic molten salt 145 has a Tₘ less than 75° C. In some embodiments, the inorganic molten salt 145 has a Tₘ less than 50° C. In some embodiments, the inorganic molten salt 145 has a Tₘ less than 30° C.

In some embodiments, the inorganic molten salt includes aluminum salts, wherein the molar percentage of aluminum salts is at least 50%. In some embodiments, the aluminum salts include aluminum chloride. In some embodiments, the inorganic molten salt electrolyte includes anions chosen from the group consisting of halides, including chlorides, bromides, and iodides.

The batteries as embodied in FIGS. 2 and 3 are non-combustible and have long cycle lives. Because the batteries in FIGS. 2 and 3 operate at low temperature, only modest amounts of energy are required to melt the salts to form the inorganic molten salt electrolyte. Consequently, only a modest input of initial energy allows the battery to become operational. In an electric vehicle, such energy may, for example, be supplied by a conventional lead acid car battery of the type required to start an internal combustion engine. Once operational, the salts remain in the molten state due to resistance heating. Consequently, computational control of charging and recharging is not required, in contrast to conventional lithium ion batteries, which depend on such computational control during charging processes in order to prevent overheating and combustion.

The inorganic molten salts have excellent ionic conductivity, and generally provide little impedance at the interface with the positive electrode. Because of the presence of the lithium-salt doped conformable polymer coating, inorganic molten salt electrolytes can include cations having a greater reduction potential than that of lithium metal. Such cations will be blocked from reaching the negative electrode surface by the conformable polymer coating, and will thus not compete with lithium ion for reduction at that surface. Moreover, the coating inhibits dendrite formation, further enhancing the cycle life of the battery. Finally, the conformable polymer coating rejects other non-lithium ionic impurities, including polysulfides associated with the polysulfide shuttle. Consequently, lithium sulfur batteries according to embodiments of the invention do not suffer performance degradation over multiple cycles.

In summary, the combination of low Tₘ inorganic molten salt electrolytes and conformable polymer architecture of the instant invention provides batteries as embodied in FIGS. 2 and 3 that are safe, efficient, have long cycle lives, and require minimal energy for startup.

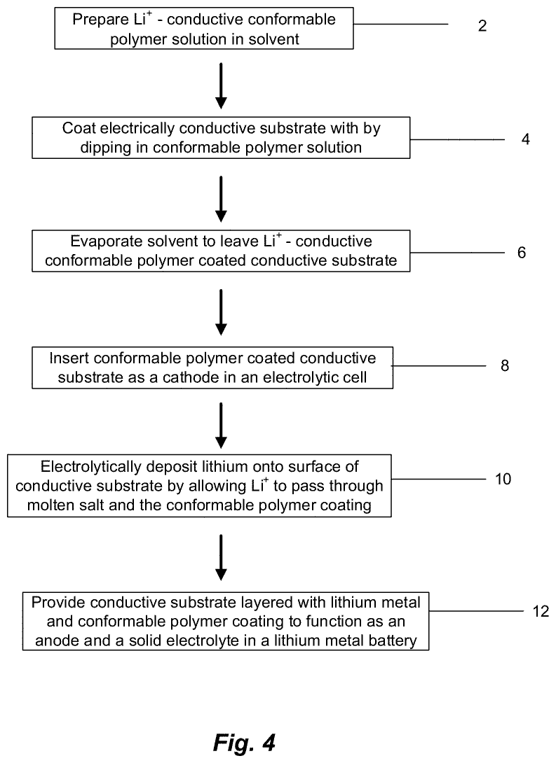

As summarized by the manufacturing steps shown in FIG. 4, in some embodiments, a conformable polymer coated lithium metal electrode is manufactured and inserted along with a positive electrode into a rechargeable cell to form a lithium metal battery, with the lithium metal electrode providing a negative electrode and the conformable polymer providing a solid electrolyte. In some such embodiments the conformable polymer is a block or graft copolymer.

The steps of this embodiment are as follows: First, prepare a solution of the lithium ion conductive conformable polymer in a solvent. For some embodiments, the conformable polymer is a block or graft copolymer and the solvent is a cosolvent capable of dissolving both A and B segments 2. Second, coat an electrically conductive substrate with the conformable polymer by dipping the substrate in the conformable polymer solution 4. Third, evaporate the solvent to leave the electrolytically conductive substrate coated with conformable polymer 6. Next, insert the conformable polymer-coated conductive substrate as a cathode in an electrolytic cell, the electrolytic cell including an anode, the anode providing a source of lithium, and an inorganic molten salt electrolyte 8. Then, apply voltage across the anode and the substrate, acting as a cathode, causing electrons to flow from the anode through an external circuit to the conductive substrate, causing lithium ions to be pulled from the anode through the inorganic molten salt electrolyte, and further to be selectively pulled through the conformable polymer coating, to be reduced at the substrate surface, thereby electrolytically plating lithium metal onto the surface. 10. As lithium metal plates, the polymer chains of the conformable polymer coating undergo a molecular rearrangement, allowing the coating to continue to cover the growing layer of lithium metal, resulting in a final product for which the substrate is coated with a layer of lithium metal, and the layer of lithium metal is in turn coated with a layer of conformable polymer solid electrolyte. In the final step, the conductive substrate layered with lithium metal and a conformable polymer solid electrolyte is inserted as the combined lithium metal negative electrode and solid electrolyte in a lithium metal battery 12.

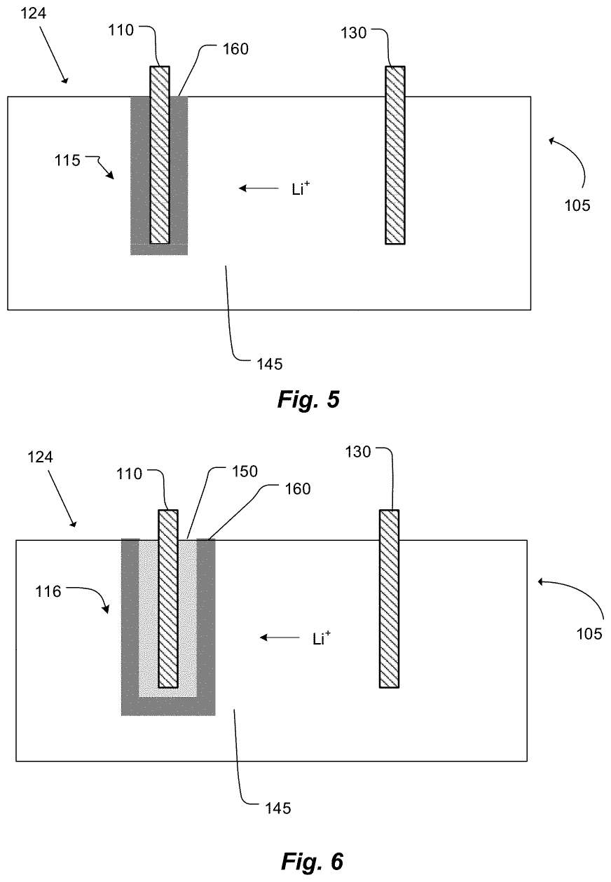

FIGS. 5 and 6 embody an electrolytic cell 124 suitable for the production of a lithium metal electrode according to the process of FIG. 4. A conductive substrate 110 that has been coated with conformable polymer 160 is inserted as the cathode of an electrolytic cell, and immersed into a inorganic molten salt electrolyte 145 juxtaposed between the conformable polymer and an anode 130 at the opposite end of the cell 124. The anode 130 provides a source of lithium ions, and can for example be a lithium metal electrode or lithium ion electrode from a recycled lithium battery. As shown in FIG. 6, as the cell operates, an external voltage causes electrons to move from the anode 130 to the conductive substrate. Lithium ions released from the anode traverse the inorganic molten salt, selectively move through the conformable polymer 160, and combine with electrons on the surface of the conductive substrate 110 to electroplate lithium metal 150 on the surface of the conductive substrate 110. As this process occurs, the conformable polymer coating 160 undergoes molecular rearrangements that allow it to adjust to volume changes and coat the growing layer of lithium metal 150. In this manner, a conformable polymer coated lithium metal electrode is obtained that can be used to make a lithium metal battery.

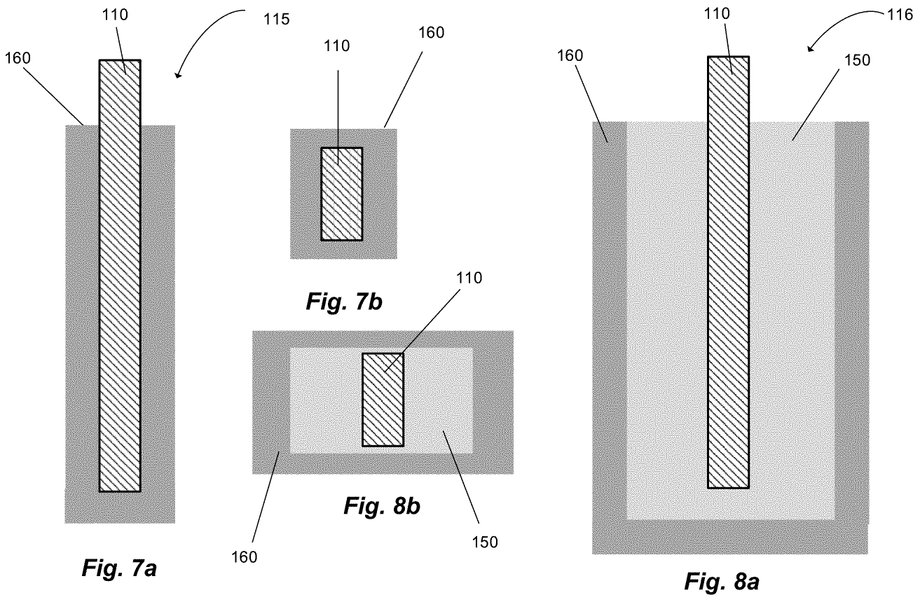

FIG. 7a shows a cross-section and FIG. 7b shows a top view of a conformable polymer coated electrically conductive substrate 110 according to embodiments of the invention. Following the process of dipping the electrically conductive substrate 110 into a conformable polymer solution and drying, the centrally located electrically conductive substrate 110 is surrounded by a layer of conformable polymer solid electrolyte 160. FIG. 8a shows a cross-section and FIG. 8b shows a top view of the conformable polymer coated lithium metal electrode that can be obtained following the electrolytic plating onto the electrically conductive substrate 110 of a layer of lithium metal 150 which fills the space between the conductive substrate 110 and the conformable polymer solid electrolyte 160.

The method of FIG. 4, as embodied in FIGS. 5 and 6, allows for the efficient and selective plating of lithium metal in the presence of ions of more noble metallic species and thereby allows for the recovery of lithium from impure sources of lithium metal and the efficient recycling of lithium metal from lithium ion and lithium metal batteries.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A rechargeable lithium metal battery comprising:
a negative electrode, the negative electrode having a conductive substrate coated with a layer of lithium metal, the layer of lithium metal having an inner face and an outer face, the inner face contacting the conductive substrate;
a positive electrode;
a solid electrolyte comprising a lithium ion conductive conformable polymer coating the outer face of the lithium metal;
a lithium salt dispersed within the solid electrolyte; and
an inorganic molten salt electrolyte, wherein the melting temperature of the inorganic molten salt electrolyte is less than 140° C.,
wherein the inorganic molten salt electrolyte is disposed between the solid electrolyte and the positive electrode, and is in direct physical contact with both the solid electrolyte and the cathode.

2. The rechargeable lithium metal battery of claim 1, wherein the lithium ion conductive conformable polymer is a graft or block copolymer with first segments and second segments, each segment above its respective glass transition temperature, T_{g}, the first segment formed from lithium ion solvating groups and the second segment being immiscible with the first segment, wherein the lithium ion conductive copolymer forms microphase separated first domains and second domains, the first domains formed from the first segments and providing continuous conductive pathways for the transport of lithium ions and the second domains formed from the second segments.

3. The rechargeable lithium metal battery of claim 1, wherein the inorganic molten salt electrolyte includes at least one ionic species having a higher reduction potential than Li⁺.

4. The rechargeable lithium metal battery of claim 1, wherein the inorganic molten salt electrolyte includes one or more salts selected from the group consisting of aluminum salts, titanium salts, alkali metal salts, alkaline earth metal salts, ammonium salts, and combinations thereof.

5. The rechargeable lithium metal battery of claim 3, wherein the inorganic molten salt electrolyte includes aluminum salts, and wherein the molar percentage of the aluminum salts is at least 50%.

6. The rechargeable lithium metal battery of claim 1, wherein the inorganic molten salt electrolyte includes anions chosen from the group consisting of halides, nitrates, nitrites, sulfates, sulfites, carbonates, hydroxides and combinations thereof.

7. The rechargeable lithium metal battery of claim 5, wherein the aluminum salts include aluminum chloride, wherein the molar percentage of aluminum chloride is at least 50%.

8. The rechargeable lithium metal battery of claim 1 wherein the positive electrode comprises elemental sulfur.

9. The rechargeable lithium metal battery of claim 2 wherein the lithium ion solvating chains comprise poly(oxyethylene)ₙ side chains, where n is an integer between 4 and 20.

10. The rechargeable lithium metal battery of claim 1 wherein the positive electrode is porous and infiltrated by the inorganic molten salt electrolyte.

11. The rechargeable lithium metal battery of claim 2 wherein the copolymer is a block copolymer.

12. The rechargeable lithium metal battery of claim 2 wherein the copolymer is a graft copolymer.

13. The rechargeable lithium metal battery of claim 2 wherein the second segments comprise poly(alkyl methacrylate).

14. The rechargeable lithium metal battery of claim 2 wherein the second segments comprise poly(dimethyl siloxane).

15. The rechargeable lithium metal battery of claim 11, wherein the lithium ion conductive copolymer is poly[(oxyethylene)₉ methacrylate]-b-poly(laurel methacrylate) (POEM-b-PLMA).

16. The rechargeable lithium metal battery of claim 12, wherein the lithium ion conductive copolymer is poly[(oxyethylene)₉ methacrylate]-g-poly(dimethyl siloxane).

17. The rechargeable lithium metal battery of claim 15 wherein the ratio of POEM to PLMA is between 55:45 and 70:30 on a molar basis.

18. The rechargeable lithium metal battery of claim 1 wherein the melting temperature of the inorganic molten salt electrolyte is less than 100° C.

19. The rechargeable lithium metal battery of claim 1 wherein the melting temperature of the inorganic molten salt electrolyte is less than 75° C.

20. The rechargeable lithium metal battery of claim 1 wherein the melting temperature of the inorganic molten salt electrolyte is less than 50° C.

21. The rechargeable lithium metal battery of claim 1 wherein the melting temperature of the inorganic molten salt electrolyte is less than 30° C.

22. A process for manufacturing a lithium metal electrode comprising:
configuring a lithium ion conductive conformable polymer coated conductive substrate as a cathode in an electrolytic cell;
configuring a lithium ion source as an anode for the electrolytic cell;
disposing an inorganic molten salt electrolyte between the solid electrolyte and the anode, so that the inorganic molten salt electrolyte is in direct physical contact with both the lithium ion conductive conformable polymer and the anode,
wherein the melting temperature of the inorganic molten salt electrolyte is less than 140° C., and wherein the inorganic molten salt electrolyte includes at least one ionic species having a higher reduction potential than Li⁺;
applying a voltage across the anode and the conductive substrate, thereby depositing a layer of lithium metal on the surface of the conductive substrate, sandwiched between the conductive substrate and the lithium ion conductive conformable polymer coating.

23. The process for manufacturing the lithium metal electrode according to claim 22, wherein the lithium ion conductive conformable polymer is a graft or block copolymer with first segments and second segments, each segment above its respective glass transition temperature, T_{g}, the first segments formed from lithium ion solvating groups and the second segments being immiscible with the first segments,
wherein the block or graft copolymer forms microphase separated first domains and second domains, the first domains formed from the first segments and providing continuous conductive pathways for the transport of lithium ions and the second domains formed from the second segments.

24. The process for manufacturing the lithium metal electrode according to claim 23, wherein the block or graft copolymer coated conductive substrate is prepared by a method including:
preparing a coating solution by dissolving the block or graft copolymer in a cosolvent, each segment of the lithium ion conductive copolymer being separately soluble in the cosolvent;
coating a conductive substrate with the coating solution;
evaporating the cosolvent from the coated conductive substrate so that the conductive substrate is coated with a layer of the block or graft copolymer.

25. The process according to claim 22, wherein the anode comprises an electrode from a recycled battery, the recycled battery being chosen from the group consisting of a lithium metal battery and a lithium ion battery.

26. A lithium metal electrode coated with lithium ion conductive conformable polymer manufactured according to the process of claim 22.

27. A lithium metal electrode coated with lithium ion conductive block or graft copolymer, manufactured according to the process of claim 23.

28. The lithium metal electrode according to claim 27, wherein the lithium ion conductive conformable polymer is a block copolymer.

29. The lithium metal electrode according to claim 27, wherein the lithium ion conductive conformable polymer is a graft copolymer.

30. The lithium metal electrode according to claim 27, wherein the first segments comprise poly(oxyethylene)ₙ side chains, where n is an integer between 4 and 20.

31. The lithium metal electrode coated with a lithium ion conductive copolymer according to claim 28, wherein the second segments comprise poly(alkyl methacrylate).

32. The lithium metal electrode coated with lithium ion conductive conformable polymer according to claim 29, wherein the second segments comprise poly(dimethyl siloxane).

33. The lithium metal electrode coated with lithium ion conductive conformable polymer according to claim 28, the block copolymer being poly[(oxyethylene)₉ methacrylate]-b-poly(laurel methacrylate) (POEM-b-PLMA).

34. The lithium metal electrode coated with lithium ion conductive conformable polymer according to claim 29, the graft copolymer being poly[(oxyethylene)₉ methacrylate]-g-poly(dimethyl siloxane).

35. The lithium metal electrode coated with lithium ion conductive conformable polymer according to claim 33, wherein the ratio of POEM to PLMA is between 55:45 and 70:30 on a molar basis.
